(19) United States
(12) Patent Application Publication
(10) Pub. No.: US 2014/0074611 A1
(43) Pub. Date: Mar. 13, 2014

(54) SYSTEM AND METHOD FOR PROVIDING, INSTALLING, AND TRACKING SIDE FAIRINGS ON TRAILERS

(71) Applicant: TODD W. BENSON, Dallas, TX (US)

(72) Inventor: TODD W. BENSON, Dallas, TX (US)

(21) Appl. No.: 13/925,425

(22) Filed: Jun. 24, 2013

Related U.S. Application Data
(60) Provisional application No. 61/663,253, filed on Jun. 22, 2012.

(51) Int. Cl. G06Q 30/02

(52) U.S. Cl. CPC G06Q 30/0261
USPC 705/14.58

(57) ABSTRACT

Disclosed are various embodiments of custom side fairing covers and methods for using such covers.

### CROSS-REFERENCE TO RELATED APPLICATIONS

This application claims benefit of U.S. Provisional Application No. 61/663,253, filed Jun. 22, 2012, entitled METHOD FOR INSTALLING SIDE FAIRINGS ON 18 WHEELER TRAILERS (Atty. Dkt. No. TDBN-31329), the specification of which is incorporated herein in its entirety.

### TECHNICAL FIELD

This application is related to side fairings and, more particularly, to side fairings for trailers.

### BACKGROUND

Current fairing systems used on trailers, such as box trailers, are lacking. Accordingly, new systems and methods are needed to address the current deficiencies.

### BRIEF DESCRIPTION OF THE DRAWINGS

For a more complete understanding, reference is now made to the following description taken in conjunction with the accompanying Drawings in which:

FIGS. 1A-1C illustrates one embodiment of a fairing covering;

FIGS. 2A-2E illustrate another embodiment of a fairing covering;

FIG. 3 illustrates one embodiment of a method for determining location based advertising fees; and

FIG. 4 illustrates one embodiment of a method for identifying and providing customized fairing coverings.

### DETAILED DESCRIPTION

Referring now to the drawings, wherein like reference numbers are used herein to designate like elements throughout, the various views and embodiments of a system and method for providing, installing, and tracking side fairings on trailers are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

The primary intent of the application is to facilitate a subsidized model for installing side fairings on 18 wheeler trailers by dual purposing the large flat eye level space as an opportunity for advertising. Truck drivers and fleet operators get increases in fuel economy (as much as 7%) immediately without any capital outlay. Simultaneously a reoccurring revenue business is created for mobile advertisements traversing large regional spaces. The business provides both an environmental improvement for the industry and provides an ongoing revenue stream for the business that subsidizes the initial installation.

To date advertising has been painted on the outside of box trailers for the operator of the freight (example HEB) but has generally not been provided for other advertising sources/targets. Although an interchangeable panel advertising business model is also planned for the large spaces on the side of the trailer, the location of the aerodynamic panels at eye-level of most drivers and the opportunity of a fuel savings incentive to install a standardized panel makes it a desirable model to target initially.

Aerodynamic panels are provided and installed at locations across the country at little or no cost. These locations will initially be synchronized to major intersections of interstates, weight station locations or high volume truck stops. In order to receive the free panels a contract is put in place that insures minimum mileage traveled for the trailer per year and that the advertisements will be left in place. The option to change the advertisement periodically is also part of the contract agreement along with other incentives for exchange frequency. Tracking of the trailer and movement may be accomplished through a simple GPS device that can also provide a feature/service to the operator for asset tracking in parallel to validating minimum contract obligations are met and valuing the exposure of an advertising asset dynamically. The intent is to make the experience as easy as possible for the truck driver or fleet company while giving a predictable, valuable advertising exposure.

Advertising is sold on an exposure basis which could be on a per mile or per month basis. If tracking of routes is coordinated with trucking companies, target region may also be something that can be segmented for a given fleet. In house graphic artists convert content from the company desiring the advertising exposure into a printable form and aspect ratio conducive to the aerodynamic panels.

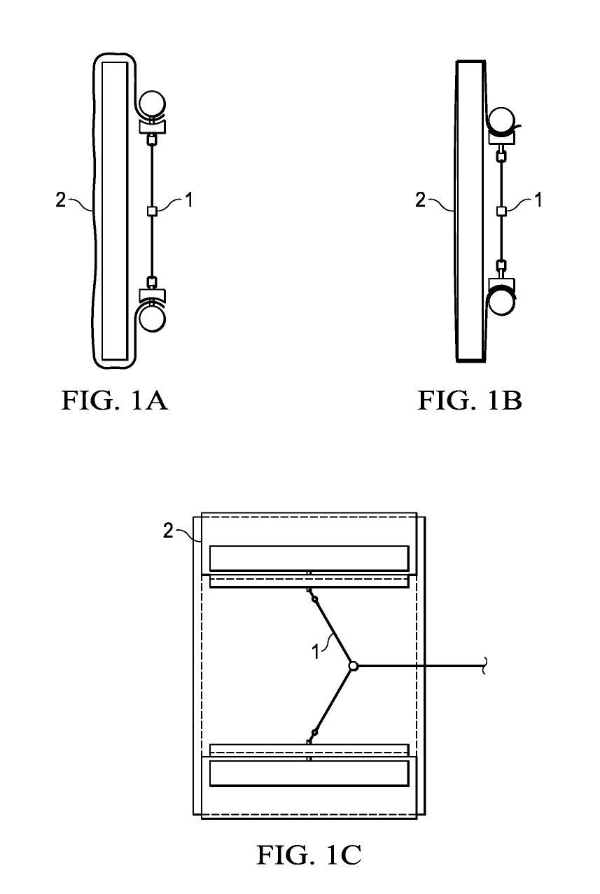

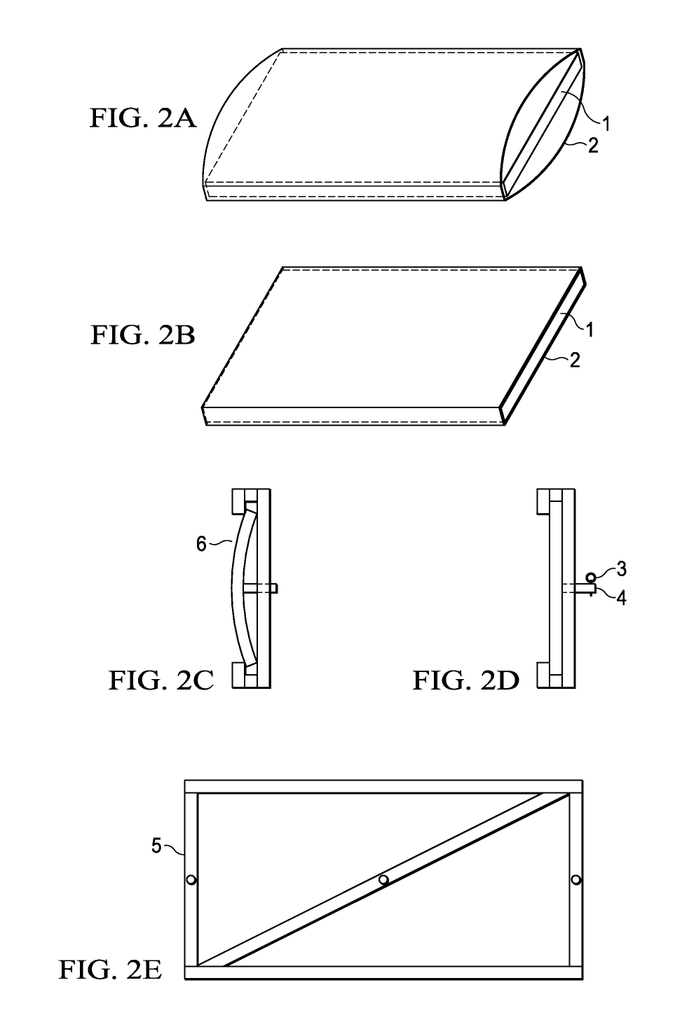

The mounting of the advertisement to the aerodynamic panels can be accomplished in many ways as illustrated, for example, in FIGS. 1A-1C and 2A-2E. Although electronic display panels may be cost effective and satisfy durability requirements in the future it is expect for the panels to be more traditional color printed content in the short term. Options include for example silkscreen printing, adhesive stickers, printed material beneath transparent retainer panels, and direct painting. One of the most likely approaches is a tubular plastic sleeve that can be slid over the rigid air diverters and thermally shrunk to fit tightly against all surfaces. The Aero panels will be configured such that a minimum number of fasteners are needed to remove and replace panels. Additionally, panels will be standardized such that the panels are actually exchanged with replacement advertising without waiting for the plastic sleeve application which can be done at a centralized location. All efforts would be made to allow the exchange of advertising to happen within typical fuel refill times and, like the initial installation, advertisement replacement stations will be placed along active trucking routes.

Further incentives to allow for more frequent advertising updates can be provided to the truck driver or company through a fuel discount at the installation points or other services such as truck washing. It is anticipated that multiple fuel vendors will want to partner/support the effort as it will create draw to their refueling locations.

Bob is a truck driver who owns his own trailer and would like to take advantage of the fuel savings he can gain from aerodynamic panels but is low on cash and keeps putting off the installation for pure cash flow reasons. With the free install he decides to have the panels installed while he sleeps at a Denver truck stop. He then drives on to California the next day with a Double Stuff Oreo add on his wind diverters.

Suzie owns a freight company that operates 200 trailers across the US. The one-time cost of adding aerodynamic panel is just too large for her company to fund and she needs here credit line available for other areas of her business. With her wide variety of routes and activity she not only gets free installation of the panels saving her 100s of thousands in fuel over the year but she also generates additional revenue of roughly $0.05/mile from the advertising immediately.

Best Western hotel chains wants to get out the word to travelers that they now allow dogs to stay in all their locations. Their target audience is families and individuals driving on vacations with their pets. Billboards are an option but it is not cost effective to place general ads across the country and difficult to share the costs between franchise hotels that vary in distance to the chosen billboard locations. A colorful add with multiple dogs running towards a Best Western sign that says “Dogs Welcome” is placed on 200 tractor trailers that traverse most of the major interstates across the country and provide high exposure at a low cost compared to the alternatives.

Allstate is spending a fortune in TV advertising and looking to find a way to better directly target drivers across the US. With relatively low cost, an advertising campaign is launched on the aerodynamic panels with catch phrases in big letters such as “Are You in Good Hands???????”

Buba's Donuts is well known in Louisiana but not in surrounding states where they intend to offer franchises and need to establish brand recognition quickly. Through the aerodynamic panel advertising service, adds for Buba's Donuts are placed on a major beer distributor's fleet that extends into 5 states targeted for Buba's expansion.

A wide variety of pricing strategies can be applied by region or even down to primary highway routes where predictable. Multiple advertisements can be placed on a single trailer and the left and right side can have different advertisements. Pricing discounts can be provided for advertisements on the side of the truck that is the same as the side of the road driven in a given country as exposure will be less as an example in the US on the right side. Percentage of mileage during daylight average may also have a minimum in the contract or provide for a bonus incentive to encourage advertisement exposure during daylight.

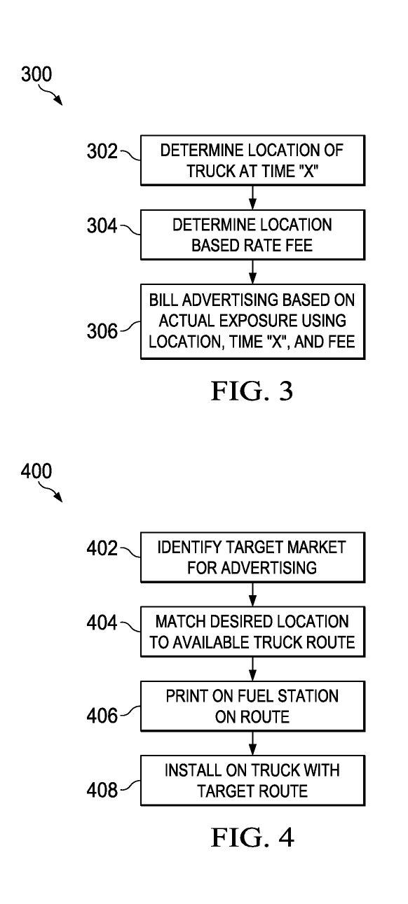

Tracking actual advertisement exposure can be done by way of GPS devices or by checkins at fuel stop locations periodically. If a contract fulfillment is not met a fee will be charged at an agreed upon prorated rate and panels will be removed. For example, as illustrated in FIG. 3, one embodiment of a method 300 includes determining a location of a truck at time X (step 302), determining a location based rate fee (step 304), and billing for advertising based on actual exposure using the location, time X, and fee (step 306).

Delivery may be performed in many ways. For example, as illustrated in FIG. 4, one embodiment of a method 400 includes identifying a target market for advertising (step 402), matching a desired advertising location to one or more available truck routes (step 404), printing the fairing covers at a fuel station or other properly equipped facility on the route (step 406), and installing the fairings on one or more trucks with the target route (step 408).

It is suspected at this time that the most successful business model would be free installation of panels with one year commitment to supporting the advertising after which time a fee/bonus would be paid to the trucker/fleet operator based on advertisement support. Advertisers will pay a per mile rate with multiple volume incentive levels. Higher demand regional exposure opportunities will be charged at premium per mile rates.

Although many of the examples are US centric, the proposed business and mounting strategies are applicable on a worldwide basis.

It will be appreciated by those skilled in the art having the benefit of this disclosure that this system and method for providing, installing, and tracking side fairings on trailers provides improved fairings. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for providing side fairings for a trailer comprising:
identifying a target market having a location;
matching the location to at least one truck route;
printing at least one custom cover corresponding to the target market on a side fairing; and
installing the custom cover on a side fairing of a truck that is assigned to the truck route.
